(19) United States
(12) Patent Application Publication
(10) Pub. No.: US 2010/0166906 A1
(43) Pub. Date: Jul. 1, 2010

(54) INPRINT EQUIPMENT

(75) Inventors: Kazunobu Hashimoto, Tsurugashima-shi (JP); Tetsuya Imai, Tsurugashima-shi (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION, Meguro-ku, Tokyo (JP)

(21) Appl. No.: 12/601,392

(22) PCT Filed: May 23, 2007
(86) PCT No.: PCT/JP2007/060497

§ 371 Date: Jan. 6, 2010

(51) Int. Cl. B29C 59/02

(52) U.S. Cl. 425/385

(57) ABSTRACT

An imprinting apparatus which includes a mold having a recess/protrusion pattern formed on a surface thereof and a pressure-applying piston that makes the mold and a transfer substrate having a transfer layer thereon come into close contact and that applies pressure to transfer shapes of the recess/protrusion pattern to the transfer layer. The imprinting apparatus comprises a mold holding unit having a mold holding surface to hold the mold; a substrate holding unit having a substrate holding surface opposed to the mold holding surface to hold the transfer substrate; and a support unit supporting the mold holding unit and the substrate holding unit in such a way as to be able to get closer to and farther from each other. The pressure-applying piston is movable along a direction intersecting with the mold holding surface and the substrate holding surface and has a pressure-applying surface that can come into contact with one of the mold holding unit and the substrate holding unit when applying pressure, and a plurality of engaging units that can engage with one of the mold holding unit and the substrate holding unit when moving back.

### TECHNICAL FIELD

The present invention relates to an imprinting apparatus that transfers a recess/protrusion pattern formed in a mold to a transfer layer.

### BACKGROUND ART

Lithography techniques generally used as techniques for pattern formation include photolithography and direct electron beam drawing. The direct electron beam drawing, for example, for manufacturing of a variety of products in small quantities. However, these lithographic techniques have various problems respectively. In the optical lithography, the pattern formation of 100 nm or less is difficult because there is a limit of the resolution due to the light wavelength. In the direct electron beam drawing, the throughput per unit time is low, and the method is not suitable for mass production. In order to overcome such limits to pattern fineness and processing capacity of the lithography techniques, which constitute a core technology of fine-structure device manufacturing technologies, considerable research on lithography employing novel methods is underway. Especially, research on nanoimprinting lithography as a technology enabling fabrication of nanometer-order design rules and being suitable for mass production is attracting attention. In this technology, a mold having a nanometer-scale concavity and convexity pattern is pressed onto a transfer layer on a substrate, and the fine concavity and convexity pattern of the mold is transferred to the transfer layer, to obtain a substrate on which is formed a fine recess/protrusion pattern.

In the usual imprinting process, the recess/protrusion pattern formed surface of a mold is pressed onto a transfer layer made of thermoplastic resin softened by heat treatment by a pressing pressure supplied from a pressure-applying piston, and keeping the pressure applied, the transfer substrate and the mold are cooled to harden the transfer layer. Then, the mold is separated from the transfer substrate, but the transfer layer and the mold are firmly stuck together and hence cannot be easily separated from each other. Accordingly, in order to make the mold easy to separate from the transfer substrate, fluorine coating or the like is performed on the recess/protrusion pattern formed surface of the mold in advance, but separating of the mold from the transfer substrate still requires a large force. Accordingly, in many imprinting apparatuses, with the mold being attached to the pressure-applying piston, the mold is separated from the transfer substrate by using a force in a separating direction generated by the pressure-applying piston.

### Reference 1: Japanese Patent Application Laid-Open Publication No. 2002-100038

### Reference 2: Japanese Patent Application Laid-Open Publication No. 2002-100079

### Reference 3: Japanese Patent Application Laid-Open Publication No. 2006-245071

### DISCLOSURE OF THE INVENTION

### Technical Problems

Generally, in the imprinting process, it is necessary to align the mold and the transfer substrate in relative positions. In particular, in cases of forming fine pattern features of the order of a nanometer by imprinting, which are necessary in production processes for magnetic record media, semiconductor devices, and so on, highly accurate alignment is needed. However, the pressure-applying piston usually does not comprise a mechanism to perform alignment, and with the mold attached to the pressure-applying piston, means for alignment is limited. Further, when the pressure-applying piston goes up and down, wobbling occurs, and hence it is difficult to achieve highly accurate alignment between the mold and the transfer substrate.

In order to align the mold and the transfer substrate in relative positions with high accuracy, the mold and the pressure-applying piston need to be provided as separate units as in apparatuses described in the above references 1 and 2. However, in this case, a mechanism to separate the mold from the transfer substrate with use of compressed air, pushing-up pins, or the like is needed, thus making the apparatus complex in configuration. Further, with the separating mechanism that uses compressed air, pushing-up pins, or the like, it is difficult to obtain an enough separating force against the sticking force between the mold and the transfer substrate, and thus the separation may not be achieved. That is, with the conventional imprinting apparatuses, it is difficult to achieve both highly accurate alignment in relative positions between the mold and the transfer substrate and reliable separation between the mold and the transfer substrate.

The present invention was made in view of the above facts, and an object thereof is to provide an imprinting apparatus which enables highly accurate alignment between the mold and the transfer substrate and can reliably separate the mold from the transfer substrate.

### Solution to Problems

An imprinting apparatus according to the present invention is an imprinting apparatus which includes a mold having a recess/protrusion pattern formed on a surface thereof and a pressure-applying piston that makes the mold and a transfer substrate having a transfer layer thereon come into close contact and that applies pressure to transfer shapes of the recess/protrusion pattern to the transfer layer. The imprinting apparatus comprises a mold holding unit having a mold holding surface to hold the mold; a substrate holding unit having a substrate holding surface opposed to the mold holding surface to hold the transfer substrate; and a support unit supporting the mold holding unit and the substrate holding unit in such a way as to be able to get closer to and farther from each other. The pressure-applying piston is movable along a direction intersecting with the mold holding surface and the substrate holding surface and has a pressure-applying surface that can come into contact with one of the mold holding unit and the substrate holding unit when applying pressure, and an engaging unit that can engage with one of the mold holding unit and the substrate holding unit when moving back.

### BRIEF DESCRIPTION OF THE DRAWINGS

FIG. 1 is a diagram showing the configuration of an imprinting apparatus according to a first embodiment of the present invention;

FIG. 2 is a diagram showing the configuration of an arm and an arm drive mechanism of the imprinting apparatus that is the embodiment of the present invention;

FIG. 3 is a top view of a pressure-applying piston having arms according to the embodiment of the present invention;

FIG. 4 is a block diagram of a control system of the imprinting apparatus that is the embodiment of the present invention;

FIG. 5 is a process chart showing a method of imprinting by the imprinting apparatus according to the present invention;

FIG. 6 is a flow chart showing the control of the operation of the imprinting apparatus of the present invention;

FIG. 7 is a process chart of the production of a discrete track media to which the imprinting process according to the present invention is applied;

FIG. 8 is a diagram showing the configuration of an imprinting apparatus according to a second embodiment of the present invention;

FIG. 9 is a diagram showing the configuration of an imprinting apparatus according to a third embodiment of the present invention;

FIG. 10 is a diagram showing the configuration of an imprinting apparatus according to a fourth embodiment of the present invention; and

FIG. 11 is a diagram showing the configuration of an imprinting apparatus according to a fifth embodiment of the present invention.

### REFERENCE SIGNS LIST

10 Mold
10a Alignment mark
20 Transfer substrate
22 Transfer layer
30 Transfer substrate holding unit
40 Mold holding unit
50 Pressure-applying piston
52 Arm
54 Arm drive mechanism
70 Image pickup device
500 Main control unit

### DETAILED DESCRIPTION OF THE INVENTION

Embodiments of the present invention will be described below with reference to the drawings. The same reference numerals are used to denote substantially the same or equivalent constituents or parts throughout the figures cited below.

### First Embodiment

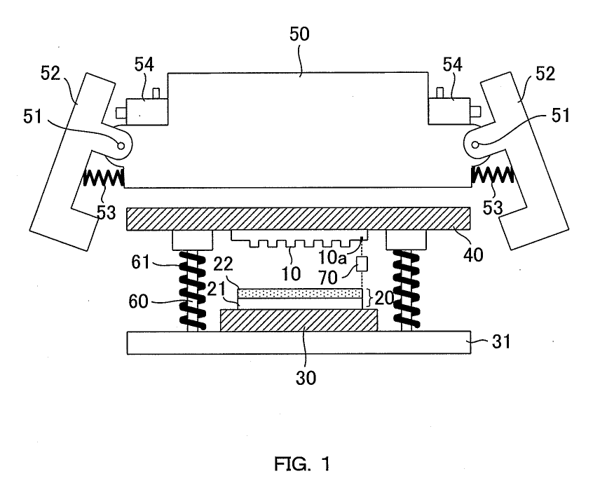

FIG. 1 shows the configuration of an imprinting apparatus according to a first embodiment of the present invention. A transfer substrate 20 is an object to be processed by the imprinting apparatus of the present invention and is formed by laying a transfer layer 22 over a substrate 21 such as a silicon wafer, a quartz substrate, an aluminum substrate, or one of these having a semiconductor layer, a magnetic layer, a ferroelectric layer, or the like laid thereon. For the transfer layer 22, there can be used a thermoplastic resin having a glass transition temperature such as PMMA (polymethyl methacrylate resin), a sol-gel-based material such as SOG (spin-on-glass) or HSQ (hydrogen silsesquioxane), or so on. Or, where the material of the substrate 21 is a material to which a fine recess/protrusion pattern formed in a mold 10 is transferable, such as a resin film, bulk resin, or low-melting point glass, the top layer of the substrate 21 can be used as the transfer layer. In this case, the pattern of the mold 10 can be transferred directly onto the substrate 21 without additionally forming a transfer layer on the substrate 21.

The mold 10 is made of, e.g., silicon, nickel (including alloy), glass, or so on and has a recess/protrusion pattern formed surface in which there is formed a fine recess/protrusion pattern to be transferred to the transfer layer 22 of the transfer substrate 20. The recess/protrusion pattern of the mold is formed by, e.g., electron beam lithography, photolithography, or the like. Further, the mold 10 has an alignment mark 10a formed near the outer edge of the recess/protrusion pattern for adjusting the position thereof relative to the transfer substrate 20. The alignment mark 10a may be in any form as long as image recognition is applicable and is formed by, e.g., grooves, lines drawn by a laser marker or the like, or so on.

A mold holding unit 40 has a flat, mold holding surface and holds the mold 10 on the mold holding surface by, e.g., vacuum sucking, electrostatic chucking, mechanical clamping, or so on. The mold holding unit 40 is supported over a transfer substrate holding unit 30 with application of a force urging upwards in the figure by support poles 60 and springs 61 provided on the support poles 60, each of the support poles 60 being connected at one end to the mold holding surface and at the other end to a base 31. The mold holding unit 40 can go up and down in directions of getting closer to and farther from the transfer substrate holding unit 30 by the springs 61 expanding and contracting.

The transfer substrate holding unit 30 is placed on the base 31 under the mold holding unit 40, has a flat, substrate holding surface opposed to the mold holding surface, and holds the transfer substrate 20 on the substrate holding surface by, e.g., vacuum sucking, electrostatic chucking, mechanical clamping, or so on. The transfer substrate holding unit 30 is constituted by a so-called XY stage and driven in directions parallel to the substrate holding surface, i.e., X-Y directions by a drive mechanism (not shown) so that the mold 10 held on the mold holding unit 40 and the transfer substrate 20 held on the transfer substrate holding unit 30 can be aligned in relative positions.

An image pickup device 70 is constituted by, e.g., a CCD camera or the like and detachably or movably provided between the mold holding unit 40 and the transfer substrate holding unit 30. The image pickup device 70 has image pickup elements on its opposite sides, that is, on the mold 10 side and the transfer substrate 20 side and captures the alignment mark 10a of the mold 10 held on the mold holding unit 40 and the outer edge of the transfer substrate 20 held on the transfer substrate holding unit 30 at the same time. The images captured by the image pickup device 70 are output to a monitor (not shown). The alignment in relative positions between the mold 10 and the transfer substrate 20 is performed with viewing the images captured by the image pickup device 70, by moving the transfer substrate holding unit 30 constituted by an XY stage in X-Y directions so that the outer edge of the transfer substrate 20 is located on a vertical line from the alignment mark 10a.

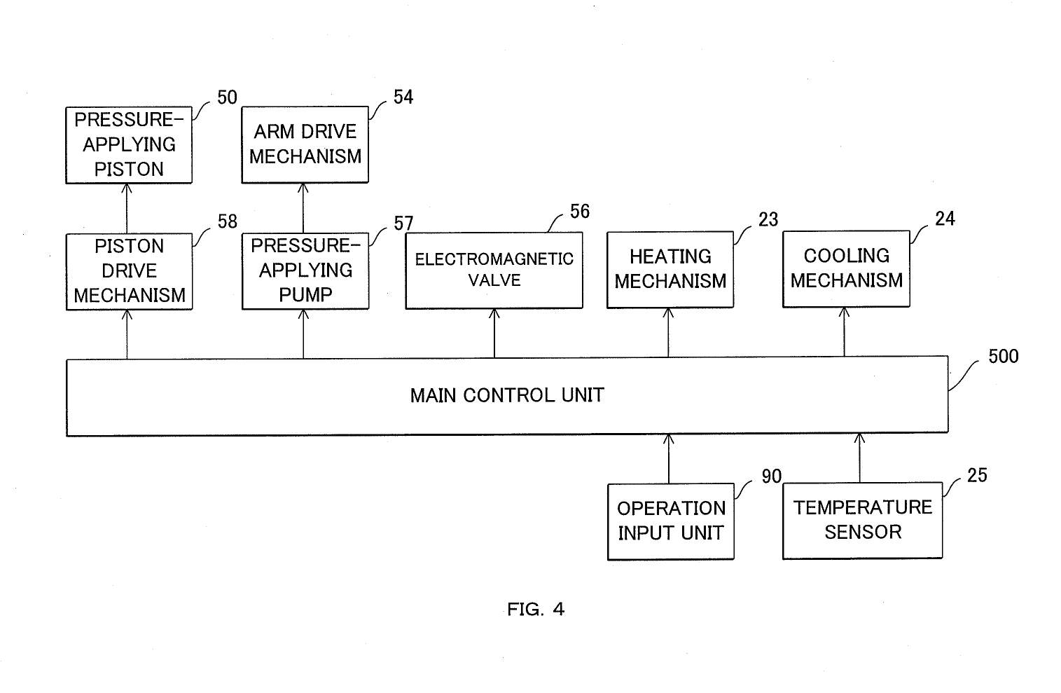

A pressure-applying piston 50 is placed away from the mold 10 and the mold holding unit 40 and linked to a piston drive mechanism 58 (see FIG. 4) constituted by a widely-known hydraulic press apparatus or the like so that it can go up and down along a direction perpendicular to the mold holding surface and the substrate holding surface. The pressure-applying piston 50, when going down, comes into contact at the bottom with the top of the mold holding unit 40 and moves the mold holding unit 40 down to cause the mold 10 and the transfer substrate 20 to come into close contact. The pressing pressure supplied from the piston drive mechanism 58 (see FIG. 4) is applied to the mold 10 and the transfer substrate 20 via the mold holding unit 40. The pressure-applying piston 50, when going up, with embracing the mold holding unit 40 with arms 52, described later, connected to the pressure-applying piston 50, supplies a force in the direction of separating the mold 10 from the transfer substrate 20.

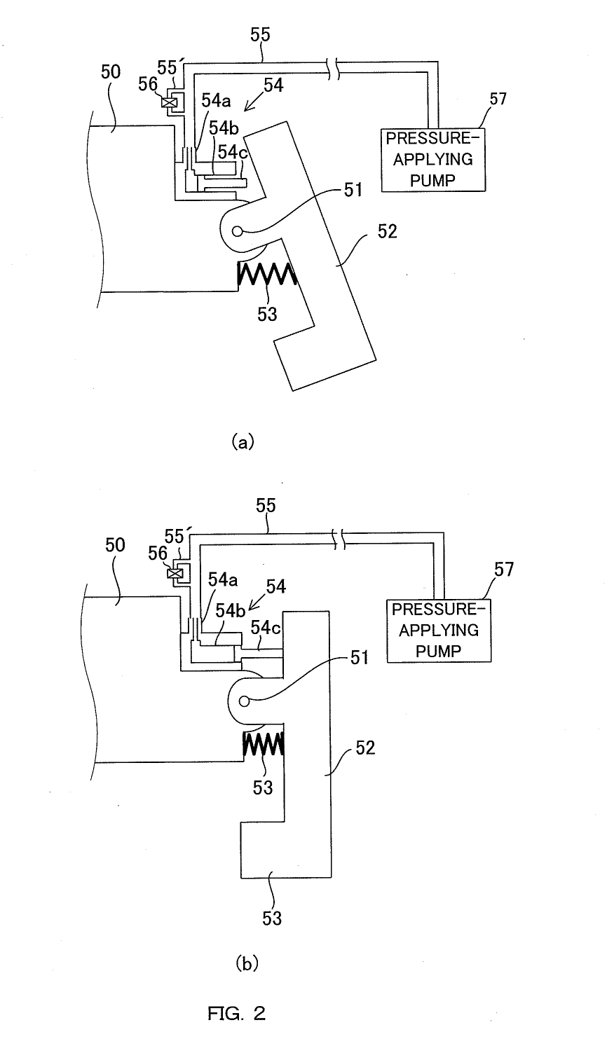

A plurality of the arms 52, which constitute engaging units of the present invention, are provided on outer edge of the pressure-applying piston 50. FIGS. 2 (a) and (b) show enlarged views of the arm 52 and an arm drive mechanism 54. The arm 52 is pivotally supported by the pressure-applying piston 50 at a shaft 51 provided along the outer edge of the pressure-applying piston 50 and is pivotable about the shaft 51 as the rotation axis. A substantially L-shaped bent portion is formed at one end of the arm 52. The arm drive mechanism 54 is a mechanism for positioning the arm 52 and comprises a cylinder 54b having a compressed air inlet 54a and a drive piston 54c. The cylinder 54b is connected via the compressed air inlet 54a and a compressed air feed passage 55 to a pressure-applying pump 57. A bypass passage 55′ is provided in the compressed air feed passage 55, and an electromagnetic valve 56 for exhausting compressed air supplied into the cylinder 54b is provided in the bypass passage 55′. FIG. 2 (a) shows the state where compressed air is not being supplied into the cylinder 54b, in which case the drive piston 54c is in a retracted position where the arm 52 is biased to be open below by a spring 53 provided below the shaft 51. Hereinafter the state of the arm 52 shown in FIG. 2 (a) is called an open state. On the other hand, when compressed air is being supplied into the cylinder 54b, as shown in FIG. 2 (b), the drive piston 54c is pushed out by air pressure in the cylinder 54b to be in contact with the upper end portion of the arm 52. Then, the drive piston 54c applies a force in the pushing-out direction to the upper end portion of the arm 52, thereby driving the arm 52 being in the open state to be substantially vertical as shown in FIG. 2 (b). Hereinafter the state of the arm 52 shown in FIG. 2 (b) is called a holding state.

After the pressure-applying piston 50 went down and has applied a pressing pressure to the mold 10 and the transfer substrate 20, when going up, the arm 52 is driven into the holding state. Thus, the bent portion at the end of the arm 52 engages with the edge of the mold holding unit 40. That is, with the edge of the mold holding unit 40 being embraced by the bent portion at the end of the arm 52, the mold holding unit 40 is lifted up in the direction of the pressure-applying piston 50 going up. By this means, a strong force is exerted on the interface between the mold 10 and the transfer substrate 20 in the separating direction, thus achieving separation.

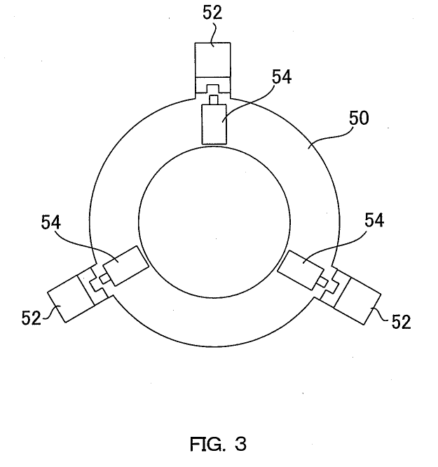

FIG. 3 is a top view of the pressure-applying piston 50 equipped with the plurality of arms 52. The pressure-applying surface of the pressure-applying piston is, for example, circular, and the arms 52 are provided along the outer edge of the pressure-applying surface. Arms 52 should be provided in at least two places of the outer edge of the pressure-applying piston 50, but arms 52 are desirably placed at equal intervals in three or more places along the outer edge of the pressure-applying piston 50 as shown in FIG. 3 so that they can efficiently apply a force in the separating direction necessary to separate the mold 10 from the transfer substrate 20. Although in this embodiment the portion at which the arm 52 engages with the mold holding unit 40 is constituted by the substantially L-shaped bent portion formed at the end thereof, this portion may be in any form as long as a portion that engages with the mold holding unit 40 while the pressure-applying piston 50 is going up is formed.

The imprinting apparatus according to the present invention comprises a heating mechanism 23 (see FIG. 4) for heating the mold 10 and the transfer substrate, a cooling mechanism 24 (see FIG. 4) for cooling them, and a temperature sensor 25 (see FIG. 4) for monitoring the temperature of the transfer substrate 20, as well as the above constituents. The heating mechanism 23 is constituted by, for example, heating elements such as electric heaters provided inside the mold holding unit 40 and the transfer substrate holding unit 30, a controller for controlling the temperatures of the heating elements, and so on. Meanwhile, the cooling mechanism 24 is constituted by, for example, a water-cooling system for circulating cooling water through the mold holding unit 40 and the transfer substrate holding unit 30 or an air-cooling fan.

The block diagram of FIG. 4 shows the configuration of the control system of the imprinting apparatus according to the present invention. A main control unit 500 is in charge of the main control of the imprinting apparatus according to the present invention and supplies drive signals and control signals to the piston drive mechanism 58, the pressure-applying pump 57, the electromagnetic valve 56, the heating mechanism 23, and the cooling mechanism 24 based on various operation instructions supplied from an operation input unit 90 and on the temperature detected signal supplied from the temperature sensor 25 detecting the temperature of the transfer substrate 20, thereby controlling the operations of those constituents. The control of the operation of the imprinting apparatus by the main control unit 500 will be described later.

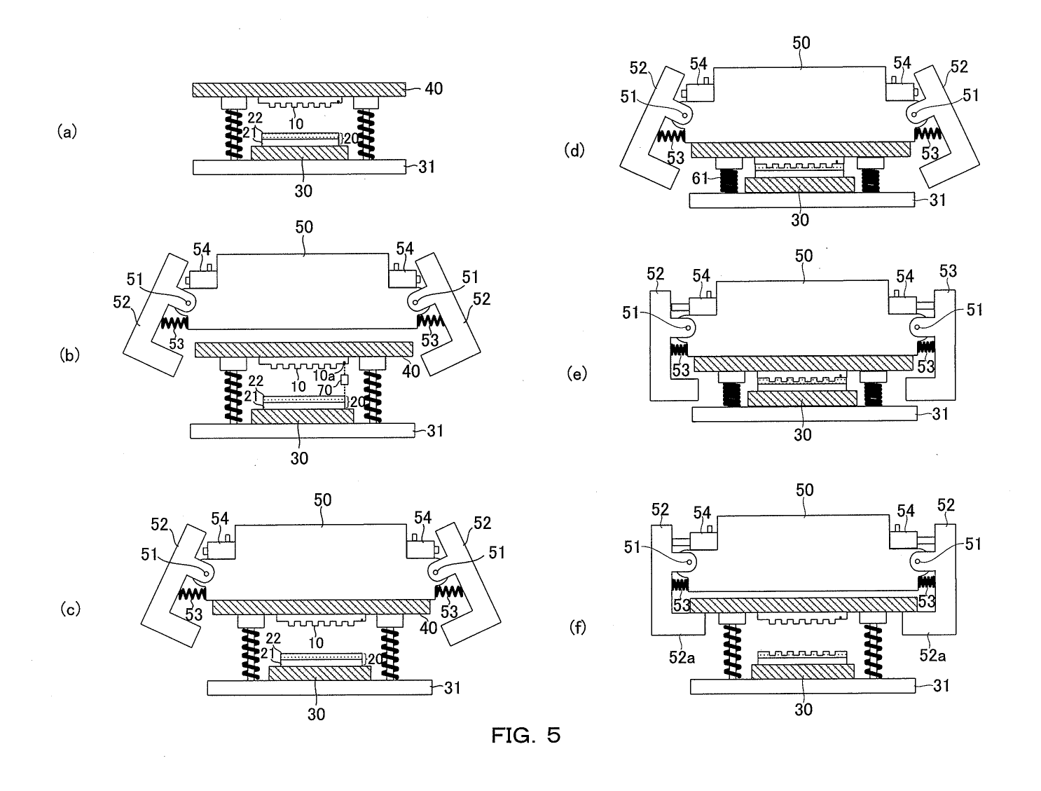

Next, an imprinting method using the above-described imprinting apparatus will be described with reference to a process chart shown in FIGS. 5 (a) to (f).

The mold 10 having a desired recess/protrusion pattern formed therein is prepared, and surface treatment with a fluorine coating agent or the like is performed on the recess/protrusion pattern formed surface of the mold 10 to prevent resin or the like used for the transfer layer from sticking and to improve separability. Then, the mold 10 is attached on the mold holding surface of the mold holding unit 40 by vacuum sucking, electrostatic chucking, mechanical clamping, or so on.

Then, the transfer substrate 20 is prepared. As the transfer substrate 20, there is used the thing obtained by coating thermoplastic resin such as acryl or polycarbonate over a flat substrate 21 constituted by, e.g., a silicon substrate, a glass substrate, an aluminum substrate, or the like by a spin coating method, a dispensing method, or the like to form the transfer layer 22. After the transfer layer 22 is formed on the substrate 21, the transfer substrate 20 is attached on the substrate holding surface of the transfer substrate holding unit 30 by vacuum sucking, electrostatic chucking, mechanical clamping, or so on (FIG. 5 (a)).

Then, the alignment in relative positions between the mold 10 and the transfer substrate 20 is performed. In the present embodiment, the alignment is performed in the following procedure using the alignment mark 10a formed on the mold 10. First, the image pickup device 70 is placed between the mold holding unit 40 and the transfer substrate holding unit 30, and images of the alignment mark 10a are captured by the image pickup element provided on the mold 10 side, and at the same time, images of the outer edge and its neighborhood of the transfer substrate 20 are captured by the image pickup element provided on the transfer substrate 20 side. Then, with monitoring the images captured by the image pickup device 70, the transfer substrate holding unit 30 is moved in X-Y directions so that the outer edge of the transfer substrate 20 is located on a vertical line from the alignment mark 10a. Thereby, the alignment in relative positions between the mold 10 and the transfer substrate 20 is finished (FIG. 5 (b)). The alignment between the mold 10 and the transfer substrate 20 is not limited to the above method, but having the mold holding unit 40 constituted by an XY stage, may be performed by moving the mold holding unit 40 in X-Y directions. Or, the alignment may be performed before attached the mold 10 and the transfer substrate 20 on the respective holding surfaces, or after with one of them attached on the respective holding surface, the alignment in relative positions is performed, the other is attached on the respective holding surface. Or, another alignment method not using an alignment mark may be adopted, or an alignment mechanism involving rotation in a θ direction as well as movement in X-Y directions may be adopted. In any case, in the imprinting apparatus according to the present invention, the mold 10 is not attached to the pressure-applying piston 50, and hence every alignment method can be adopted and highly accurate alignment can be performed. After the relative positions of the mold 10 and the transfer substrate 20 are adjusted, the image pickup device 70 is removed out of the way along which the pressure-applying piston 50 moves.

Next, the mold 10 and the transfer substrate 20 are heated to the softening temperature of the transfer layer 22 or higher by the heating mechanism 23. The softening temperature of the transfer layer 22 is at the transition temperature (Tg) in the case where the transfer layer 22 is made of polymer material. In contrast, in the case where the transfer layer 22 is made of crystalline polymer material, the layer may not soften even when the temperature exceeds Tg and may soften at close to the melting temperature. Further, a heat distortion temperature (Td) that is defined as the temperature at which material having a certain load imposed thereon becomes deformed by a certain amount is also referred to as the softening temperature.

When the transfer layer 22 has soften, the piston drive mechanism 58 is driven to lower the pressure-applying piston 50 linked thereto so as to cause the bottom surface, i.e., the pressure-applying surface of the pressure-applying piston 50 to come into contact with the top of the mold holding unit 40. At this time, the arms 52 are driven to be in the open state so as not to interfere with the mold holding unit 40 (FIG. 5 (c)).

When the pressure-applying piston 50 further goes down, the mold holding unit 40 together with the pressure-applying piston goes down, so that the recess/protrusion pattern formed surface of the mold 10 and the transfer layer 22 of the transfer substrate 20 come into close contact. With the mold 10 and the transfer substrate 20 being in close contact, the pressure-applying piston 50 keeps applying the pressing pressure until a predetermined time has passed. Since the transfer layer 22 has been softened by heating, the transfer layer 22 is deformed along the fine shapes of the recess/protrusion pattern of the mold 10. Because the mold 10 itself is also heated to the softening temperature of the transfer layer 22, the softening of the transfer layer 22 is promoted. The pressure to press the mold 10 onto the transfer layer 22 and its duration are set as needed according to the shapes of the recess/protrusion pattern of the mold 10, the material of the transfer layer 22, and the like (FIG. 5 (d)).

Then, the mold 10 and the transfer substrate 20 are cooled by the cooling mechanism 24 to harden the transfer layer 22. Note that the cooling of the mold 10 and the transfer substrate 20 is not limited to forced cooling by the cooling mechanism 24 but may be performed by natural heat radiation or lowering stepwise the heating temperature of the heating mechanism 23.

Next, the mold 10 is separated from the transfer substrate 20. At this time, first, the arms 52 connected to the pressure-applying piston 50 are driven to be in the holding state (FIG. 5 (e)). Then the piston drive mechanism 58 is driven to raise the pressure-applying piston 50. By this means, the arms 52 engage at the bent portion formed at their end with the edge of the mold holding unit 40, with the mold holding unit 40 being embraced by the arms 52. In this state, the pressure-applying piston 50 further goes up, and thereby a force in the separating direction is exerted on the interface between the mold 10 and the transfer substrate 20. That is, by using a strong force to raise the pressure-applying piston 50 generated by the piston drive mechanism 58, the separation between the mold 10 and the transfer substrate 20 is performed. By performing the separation using the strong force to raise the pressure-applying piston 50, the mold 10 can be reliably separated from the transfer substrate 20 (FIG. 5 (f)).

By undergoing the above steps, the fine recess/protrusion pattern of the mold 10 is transferred to the transfer layer 22 on the transfer substrate 20.

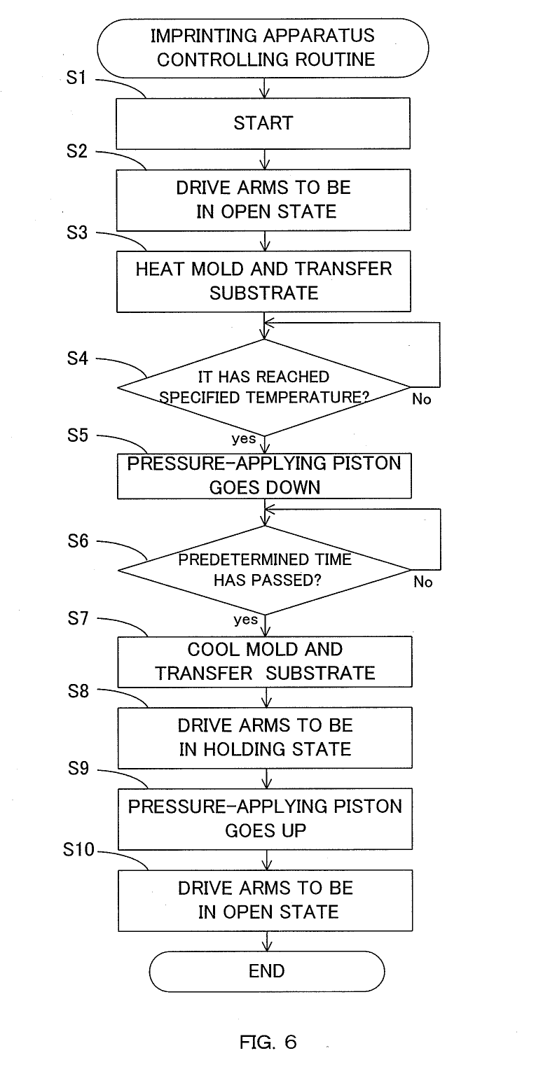

Next, the control of the operation of the imprinting apparatus by the main control unit 500 in the above series of imprinting process steps will be described with reference to the flow chart of FIG. 6.

When an instruction to start the imprinting apparatus is input from the operation input unit 90 (step S1), the main control unit 500 supplies a drive signal to the electromagnetic valve 56 to drive the electromagnetic valve 56 to be open. By this means, the electromagnetic valve 56 gets in an open valve state to cause pressure inside the cylinder 54b of the arm drive mechanism 54 to be at the atmospheric pressure, driving the arms 52 to be in the open state (step S2). Subsequently, the mold 10 is attached on the mold holding unit 40, and the transfer substrate 20 is attached on the transfer substrate holding unit 30. After the alignment between the two is finished, when the heating temperature of the mold 10 and the transfer substrate 20 is input from the operation input unit 90, the main control unit 500 receives an instruction to set the temperature from the operation input unit 90 and supplies the heating mechanism 23 with a control signal according to the specified temperature. In the heating mechanism 23, the temperature controller (not shown) controls the heat generation of the heating elements (not shown) based on this control signal so that the mold 10 and the transfer substrate 20 are at the specified temperature (step S3). Subsequently, the main control unit 500 determines whether the temperature of the transfer substrate 20 has reached the specified temperature based on the temperature detected signal supplied from the temperature sensor 25 (step S4). When the temperature of the transfer substrate 20 has reached the specified temperature, the main control unit 500 supplies a drive signal to the piston drive mechanism 58 to lower the pressure-applying piston 50 (step S5). By this means, the pressure-applying piston 50 comes into contact at the bottom surface with the top of the mold holding unit 40 and lowers the mold holding unit 40. Then, the pressure-applying piston 50 makes the mold 10 and the transfer substrate 20 come into close contact and presses the mold 10 onto the transfer substrate 20 by a predetermined pressing pressure. After a predetermined time has passed from the time when the pressure-applying piston 50 started applying pressure (step S6), the main control unit 500 supplies the cooling mechanism 24 with a control signal to start cooling (step S7). The cooling mechanism 24 cools the mold 10 and the transfer substrate 20 according to this control signal to harden the transfer layer 22 formed on the transfer substrate 20. Then, after supplying the electromagnetic valve 56 with a drive signal to drive the electromagnetic valve 56 to be closed, the main control unit 500 supplies the pressure-applying pump 57 with a control signal to start supplying compressed air. By this means, compressed air is fed into the cylinder 54b of the arm drive mechanism 54, driving the arms 52 to be in the holding state (step S8). Subsequently, the main control unit 500 supplies a drive signal to the piston drive mechanism 58 to raise the pressure-applying piston 50 (step S9). The arms 52 are driven in the holding state, and the pressure-applying piston 50 goes up. Thereby the mold holding unit 40 is embraced by the arms 52 and the separation between the mold 10 and the transfer substrate 20 is performed. When the mold 10 has been separated from the transfer substrate 20 and the pressure-applying piston 50 has gone up to an initial position, the main control unit 500 supplies a drive signal to drive the electromagnetic valve 56 to be in the open valve state after stopping the driving of the pressure-applying piston 50 and the pressure-applying pump 57. By this means, the arms 52 are driven to be in the open state, thus releasing the transfer substrate holding unit 30.

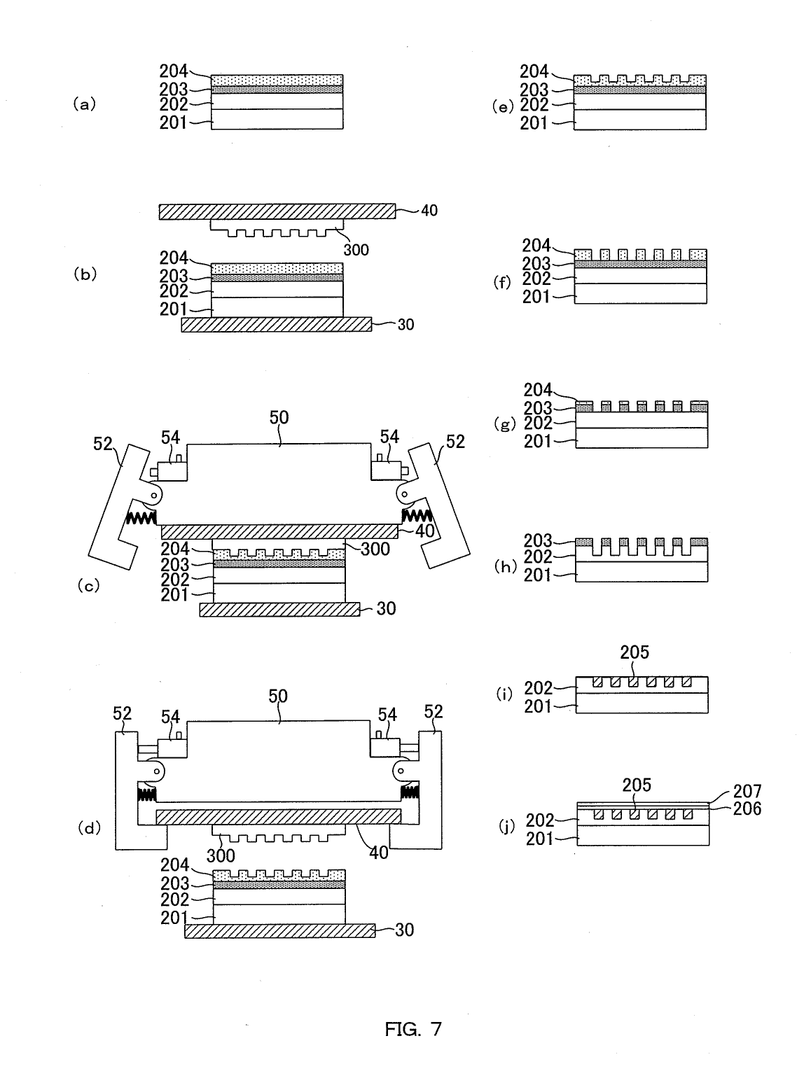

The imprinting method according to the present invention can be applied to production processes of magnetic record media such as patterned media. Discrete track media, that are a type of patterned media, are record media configured to have grooves formed between data tracks made of magnetic material, where by filling these grooves with nonmagnetic material, the data tracks are separated physically and magnetically. Discrete track media are attracting attention as a breakthrough technology for achieving further higher record densities of magnetic record media because a harmful effect such as side write or crosstalk due to the record density becoming higher can be reduced. A production process of a discrete track media including the above imprinting process will be described with reference to a production process chart shown in FIG. 7.

First, a mold 300 having a desired recess/protrusion pattern on a surface of a base material made of silicon, glass, or the like is produced. The recess/protrusion pattern is formed on the surface of the mold 300 by using electron beam lithography or another method to form a resist pattern, and then using the resist pattern as a mask to perform dry etching or similar. The completed mold 300 is surface-treated with a silane coupling agent or similar to improve separation properties. Note that a duplicate of nickel (including alloy) or the like produced by a method such as electroforming with the mold 300 as a master may be used as a mold for pattern transferring.

Next, a discrete track media substrate (hereinafter called a media substrate) 200 is produced. The media substrate 200 is formed by laying a recording layer 202 and a metal mask layer 203 one over the other on a substrate 201 formed of, e.g., specially treated chemically reinforced glass, a silicon wafer, an aluminum substrate, or the like. The recording layer 202 is formed by sequentially laying a soft magnetic underlying layer, an intermediate layer, and a ferromagnetic layer one over another by a sputtering method, and the metal mask layer 203 is formed of, e.g., Ta, Ti, or the like by a sputtering method (FIG. 7 (a)).

Then, the recess/protrusion pattern of the mold 300 is transferred by the above imprinting method to a transfer layer 204 formed over the media substrate 200. That is, the transfer layer 204 of thermoplastic material is formed by spin coating or the like over the media substrate 200 prepared by the above process, and after the mold 300 is attached on the mold holding unit and the media substrate 200 is attached on the transfer substrate holding unit 30, the relative positions of the media substrate 200 and the mold 300 are adjusted (FIG. 7 (b)).

When the alignment has finished, the media substrate 200 and the mold 300 are heated. When it has reached the softening temperature of the transfer layer 204, the mold 300 and the media substrate 200 are put in close contact, and by applying pressure, pattern transfer is performed (FIG. 7 (c)).

Subsequently, the mold 300 and the media substrate 200 are cooled to harden the transfer layer 204. Then, the arms 52 are driven into the holding state, and the pressure-applying piston 50 is raised. The mold 300 is separated from the media substrate 200 by using the force of the pressure-applying piston 50 going up with the mold holding unit 40 being embraced by the arms 52. Through the above process, the recess/protrusion pattern of the mold 300 is transferred to the transfer layer 204 formed over the media substrate 200 (FIG. 7 (d)).

Then, because a remaining film of the transfer layer 204 is left on parts of the substrate corresponding to the protrusions of the mold 300, the remaining film is removed by oxygen reactive ion etching (RIE) (FIG. 7 (e)). Next, the transfer layer 204 which has been patterned in the above imprinting process is used as a mask in performing dry etching to etch the metal mask layer 203 and perform patterning (FIG. 7 (g)).

Then, after the remaining transfer layer 204 on the media substrate 200 is removed by wet etching or dry ashing, the metal mask layer 203 is used as a mask in dry etching to etch the recording film layer 202, to form grooves in the recording film layer 202 (FIG. 7 (h)). Next, after the remaining metal mask layer 203 is removed by wet etching or dry etching, nonmagnetic material 205 is coated to fill the grooves, and the surface thereof is flattened by etching, chemical polishing, or so on (FIG. 7 (i)).

Then, a surface protective layer 206 of diamond-like carbon (DLC) excellent in lubricity and hard to wear or the like is formed by a CVD method or a sputtering method, and further a lubricant of perfluoropolyether (PFPE) diluted with a solvent, or the like is coated over by a dipping method or a spin coating method to form a lubricant layer 207 (FIG. 7 (j)).

By undergoing the above process steps, a discrete track media to which the imprinting method according to the present invention has been applied is finished.

As apparent from the above description, with the imprinting apparatus according to the present invention, because the mold is not fixed to the pressure-applying piston, the alignment between the mold and the transfer material can be performed with high accuracy. Further, the plurality of arms to engage with the mold holding unit when the pressure-applying piston goes up are provided on the pressure-applying piston, and the mold holding unit is raised in the going-up direction of the pressure-applying piston with being embraced by the arms. Hence, the mold can be separated from the transfer substrate by using the strong force which raises the pressure-applying piston. That is, with the imprinting apparatus according to the present invention, a stronger separating force can be obtained than with the conventional apparatuses equipped with a separating mechanism that uses compressed air, pushing-up pins, or the like, and thus the separation between the mold and the transfer material can be reliably performed.

### Second Embodiment

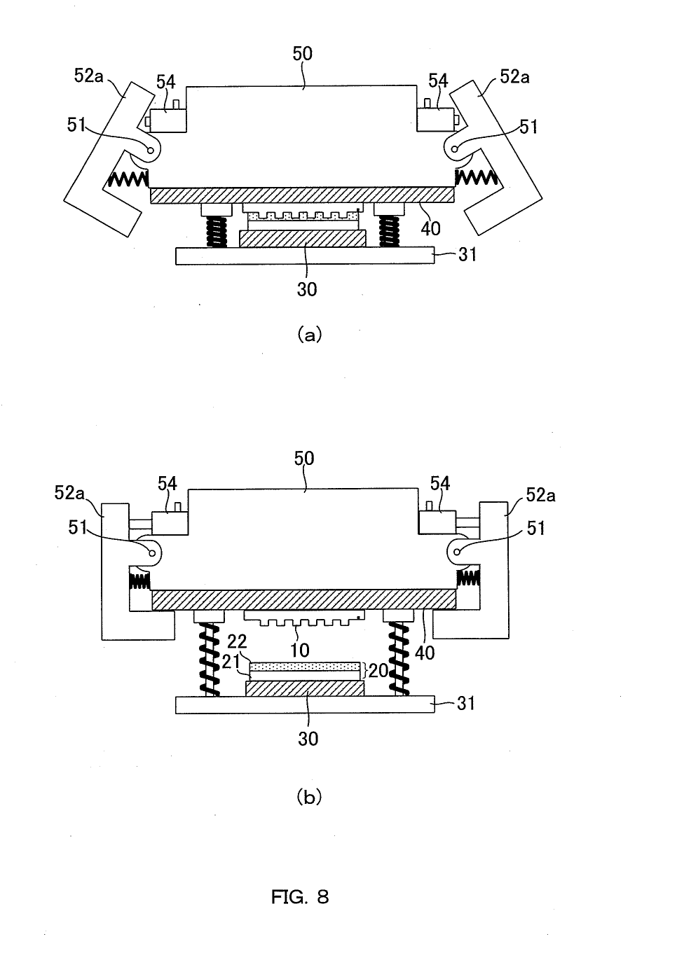

FIGS. 8 (a) and (b) show the configuration of an imprinting apparatus according to a second embodiment of the present invention. The imprinting apparatus according to the present embodiment differs in the length of the arms from that of the above first embodiment. That is, the arms 52a of the imprinting apparatus according to this embodiment are formed shorter than those of the imprinting apparatus of the first embodiment. When the pressure-applying piston 50 goes down, thus causing the mold 10 and the transfer substrate 20 to come into close contact and applying pressure thereto, the arms 52a are driven to be in the open state so as not to interfere with the mold holding unit 40 as shown in FIG. 8 (a). In contrast, when the pressure-applying piston 50 goes up, the arms 52a are driven to be in the holding state as shown in FIG. 8 (b). At this time, the mold holding unit 40 is sandwiched between the bent portions formed at the ends of the arms 52a and the bottom surface of the pressure-applying piston 50. That is, since the arms 52a are formed short in length, when the mold holding unit 40 is embraced by the arms 52a, there is no clearance between the top of the mold holding unit 40 and the bottom of the pressure-applying piston 50, with the mold holding unit 40 being clamped. In this way, the mold holding unit 40 is bound and thereby can be prevented from jumping up at the time that the mold 10 is separated from the transfer substrate 20.

### Third Embodiment

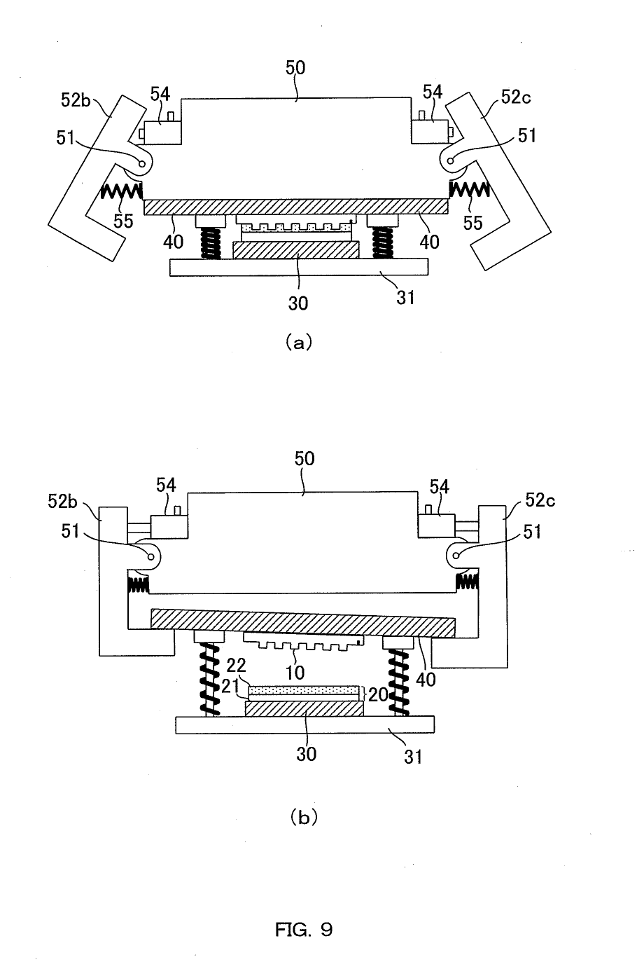

FIGS. 9 (a) and (b) show the configuration of an imprinting apparatus according to a third embodiment of the present invention. In the imprinting apparatus according to the present embodiment, one of a plurality of arms is formed shorter than the other arms. In FIG. 9, the arm 52b located on the left side in the figure is formed shorter than the arm 52c located on the right side in the figure. When the pressure-applying piston 50 goes down, thus causing the mold 10 and the transfer substrate 20 to come into close contact and applying pressure thereto, the arms 52b and 52c are driven to be in the open state so as not to interfere with the mold holding unit 40 as shown in FIG. 9 (a). In contrast, when the pressure-applying piston 50 goes up, the arms 52b and 52c are driven to be in the holding state as shown in FIG. 9 (b). Thereafter, when the pressure-applying piston 50 has started going up, first, the end of the arm 52b shortest in length engages with the edge of the mold holding unit 40. By this means, the upward force of the pressure-applying piston is concentrated on the portion on the left side in the figure, and hence a large force in the separating direction is exerted on this portion, so that the separation between the mold 10 and the transfer substrate 20 can be easily performed.

### Fourth Embodiment

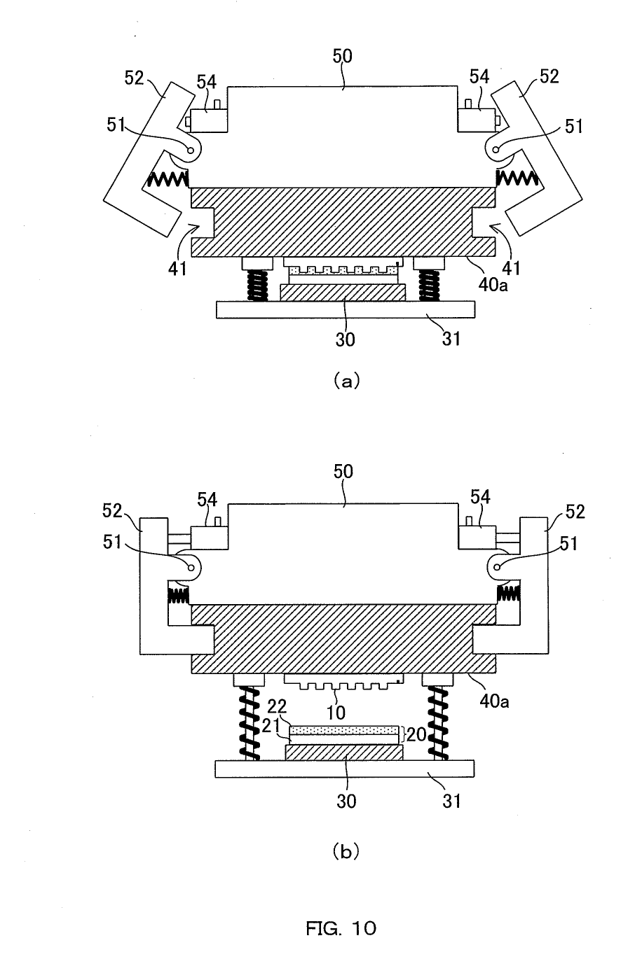

FIGS. 10 (a) and (b) show the configuration of an imprinting apparatus according to a fourth embodiment of the present invention. In the imprinting apparatus according to the present embodiment, a plurality of hollows 41 to engage with the arms 52 are formed in the side surfaces of a mold holding unit 40a. When the pressure-applying piston 50 goes down, thus causing the mold 10 and the transfer substrate 20 to come into close contact and applying pressure thereto, the arms 52 are driven to be in the open state so as not to interfere with the mold holding unit 40a as shown in FIG. 10 (a). In contrast, when the pressure-applying piston 50 goes up, the arms 52 are driven to be in the holding state as shown in FIG. 10 (b). At this time, the ends of the arms 52 engage with the hollows 41 formed in the side surfaces of the mold holding unit 40a. In this state, the pressure-applying piston 50 starts going up, and thereby a force in the separating direction is exerted on the interface between the mold 10 and the transfer substrate 20. As such, with the mold holding unit 40 being clamped at the side surfaces with the arms 52, also, the separation using the force produced when the pressure-applying piston goes up can be performed.

### Fifth Embodiment

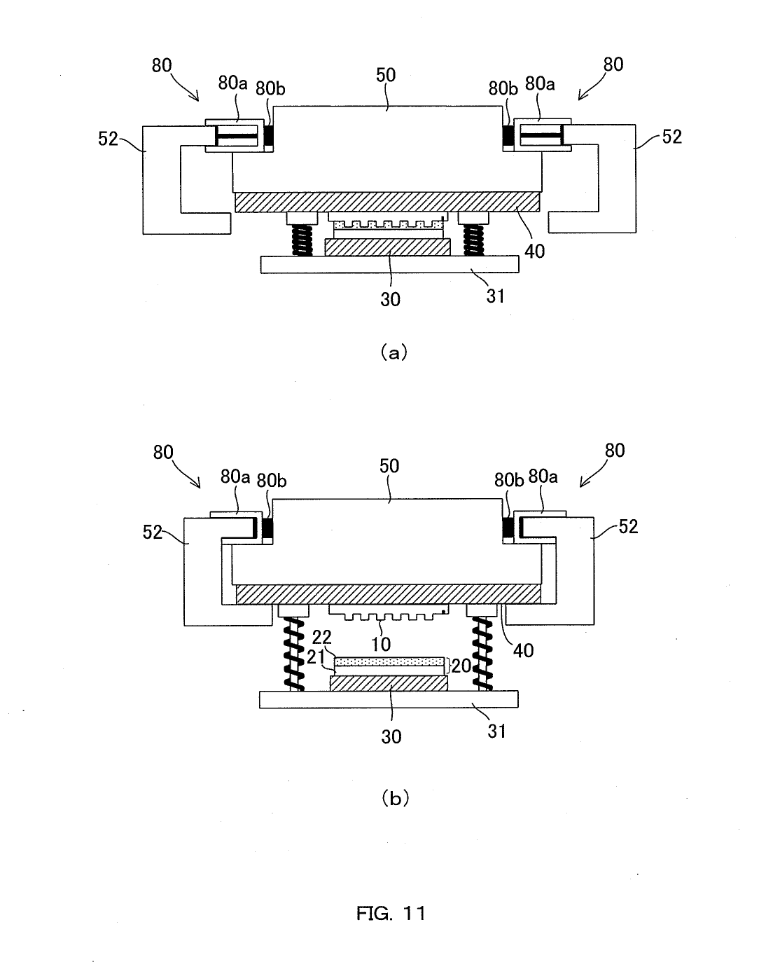

FIGS. 11 (a) and (b) show the configuration of an imprinting apparatus according to a fifth embodiment of the present invention. The imprinting apparatus according to the present embodiment differs in the mechanism for driving the arms 52 from those of the above embodiments. That is, in the imprinting apparatuses according to the first to fourth embodiments, the arms 52 are pivotable about the shaft 51 as the rotation axis and positioned in the open state or the holding state by the arm drive mechanism 54. Meanwhile, in the imprinting apparatus according to this embodiment, the arms 52 are slid horizontally, i.e., in directions parallel to the pressure-applying surface of the pressure-applying piston 50 by sliding mechanisms 80, and thereby are positioned in the open state or the holding state. The sliding mechanism 80 has a guide unit 80a and a drive unit 80b constituted by a linear solenoid or the like and slides the arm 52 connected to the plunger end of the linear solenoid 80b along the inner wall of the guide unit. When the pressure-applying piston 50 goes down, thus causing the mold 10 and the transfer substrate 20 to come into close contact and applying pressure thereto, the sliding mechanisms 80 slide the arms 52 outwards so that the arms 52 do not interfere with the mold holding unit 40 as shown in FIG. 11 (a). This state of the arms 52 corresponds to the open state described above. In contrast, when the pressure-applying piston 50 goes up, the sliding mechanisms 80 slide the arms 52 inwards as shown in FIG. 11 (b). This state of the arms 52 corresponds to the holding state described above. With the drive mechanisms for the arms 52 being constituted by such sliding mechanisms, also, the same operation effect as in the above embodiments can be obtained.

In the above embodiments, the pressure-applying piston is made to come into contact with the mold holding unit and to lower the mold holding unit, thereby performing the pattern transfer, and the arms are made to engage with the mold holding unit and then the mold holding unit is raised, thereby performing the separation. However, the pressure-applying piston may be made to come into contact with the transfer substrate and to lower the transfer substrate, thereby performing the pattern transfer, and the arms may be made to engage with the transfer substrate and then the transfer substrate may be raised, thereby performing the separation.

Further, although in the above embodiments the imprinting apparatus is configured such that when the pressure-applying piston goes down, the pressing pressure is applied and that when it goes up, the separation is performed, it may be configured such that when the pressure-applying piston goes up, the pressing pressure is applied and that when it goes down, the separation is performed.

1. An imprinting apparatus which includes a mold having a recess/protrusion pattern formed on a surface thereof and a pressure-applying piston that makes said mold and a transfer substrate having a transfer layer thereon come into close contact and that applies pressure to transfer shapes of said recess/protrusion pattern to said transfer layer, said imprinting apparatus comprising:
a mold holding unit having a mold holding surface to hold said mold;
a substrate holding unit having a substrate holding surface opposed to said mold holding surface to hold said transfer substrate; and
a support unit supporting said mold holding unit and said substrate holding unit in such a way as to be able to get closer to and farther from each other,
wherein said pressure-applying piston is movable along a direction intersecting with said mold holding surface and said substrate holding surface and has a pressure-applying surface that can come into contact with one of said mold holding unit and said substrate holding unit when applying pressure, and an engaging unit that can engage with one of said mold holding unit and said substrate holding unit when moving back.

2. An imprinting apparatus according to claim 1, wherein said engaging unit engages with an edge of said mold holding surface or said substrate holding surface.

3. An imprinting apparatus according to claim 1, further comprising:
a drive mechanism to position said engaging unit,
wherein said drive mechanism positions said engaging unit in such a position as to touch neither said mold holding unit nor said substrate holding unit when said pressure-applying piston applies pressure.

4. An imprinting apparatus according to claim 3, wherein said drive mechanism makes said engaging unit pivot about a rotation axis along a direction of an outer edge of said pressure-applying surface.

5. An imprinting apparatus according to claim 3, wherein said drive mechanism moves said engaging unit in a direction parallel to said pressure-applying surface.

6. An imprinting apparatus according to claim 1, wherein when said pressure-applying piston moves back, one of said mold holding unit and said substrate holding unit is sandwiched between said pressure-applying surface and said engaging unit.

7. An imprinting apparatus according to claim 1, wherein said engaging unit has a plurality of arms, and when said pressure-applying piston moves back, one of said arms engages with one of said mold holding unit and said substrate holding unit earlier than the other arms do.

8. An imprinting apparatus according to claim 1, wherein at least one of said mold holding unit and said substrate holding unit has at least one hollow in a side surface thereof, and said engaging unit engages with said hollow.

9. An imprinting apparatus according to claim 1, wherein said engaging unit has a plurality of arms which placed at equal intervals along the outer edge of said pressure-applying piston.
